(19) United States
(12) Patent Application Publication
(10) Pub. No.: US 2025/0025917 A1
(43) Pub. Date: Jan. 23, 2025

(54) MECHANICAL METHOD AND MECHANICAL SEPARATING DEVICE FOR SEPARATING PLASTICALLY DEFORMABLE PLATE-LIKE WORKPIECES OF A WORKPIECE STACK, AND MECHANICAL FEEDING DEVICE AND MECHANICAL ASSEMBLY FOR WORKPIECE MACHINING

(71) Applicant: TRUMPF SACHSEN SE, Neukirch (DE)

(72) Inventors: Matthias DENECKE, Bautzen (DE); Norbert GRUHL, Hochkirch/OT Lehn (DE); David SCHÖNE, Kamenz (DE)

(21) Appl. No.: 18/906,322

(22) Filed: Oct. 4, 2024

Related U.S. Application Data
(63) Continuation of application No. PCT/EP2023/057982, filed on Mar. 28, 2023.

(30) Foreign Application Priority Data
Apr. 7, 2022 (DE) 10 2022 108 450.7

(51) Int. Cl. B07B 15/00

(52) U.S. Cl. CPC B07B 15/00

(57) ABSTRACT

A method for separating plastically deformable plate-like workpieces of a workpiece stack is provided. The workpieces are arranged adjacent to one another and are aligned with workpiece main planes parallel to one another. The method includes separating two adjacent workpieces from one another by generating a separating gap between the adjacent workpieces at a workpiece edge. The generating the separating gap includes acting upon at least one workpiece of the two adjacent workpieces by a force at an end side of the workpiece edge parallel to a respective workpiece main plane, thereby compressing the workpiece with formation of an edge-side thickened portion that projects perpendicular to the respective workpiece main plane with respect to a remaining portion of the workpiece. As the workpiece is acted upon by the force, the workpiece is inhibited against an evasive movement caused by the force.

### CROSS REFERENCE TO RELATED APPLICATIONS

This application is a continuation of International Application No. PCT/EP2023/057982 (WO 2023/194156 A1), filed on Mar. 28, 2023, and claims benefit to German Patent Application No. DE 10 2022 108 450.7, filed on Apr. 7, 2022. The aforementioned applications are hereby incorporated by reference herein.

### FIELD

Embodiments of the present invention relate to a mechanical method for separating plastically deformable plate-like workpieces of a workpiece stack, preferably plastically deformable sheets of a sheet stack, in which workpieces, preferably sheets, are arranged adjacent to one another and are aligned with workpiece main planes parallel to one another. Embodiments of the present invention also relate to a mechanical separating device for carrying out the above-mentioned method, a mechanical feeding device for feeding a functional unit of a mechanical arrangement for the processing of plastically deformable plate-like workpieces, preferably of plastically deformable sheets, with a plastically deformable plate-like workpiece, preferably with a plastically deformable sheet, and a mechanical arrangement for the processing of plastically deformable plate-like workpieces, preferably of plastically deformable sheets, with a functional unit and with a mechanical feeding device of the above type for feeding the functional unit.

### BACKGROUND

The category-defining prior art is known from EP 0 639 519 A1. This document relates to a mechanical feeding device provided for automation of sheet manufacture for the transfer of previously separated sheets of a sheet stack. The feeding device has a suction frame on which retaining suckers and separating suckers are fitted next to one another. In order to take up a sheet which lies at the top in a sheet stack, the suction frame is placed with the retaining suckers and the separating suckers onto the upper side of the sheet in such a manner that the retaining suckers come to lie inside the sheet and the separating suckers come to lie on the edge of the sheet. After applying a vacuum to the separating suckers, the separating suckers are pivoted upwards with the sheet edge sucked on by these about an axis running parallel to a sheet main plane. As a result of the pivoting movement, the sheet edge held by the separating suckers is bent upwards and as a result of this is ideally separated from edge of the sheet lying below it. In particular in the case of oiled sheets and/or sheets which are provided with films and consequently adhere to one another, there is, however, the risk that the sheet lying below the sheet contacted directly by the separating suckers is bent upward together with the sheet suctioned directly by the separating suckers and that the desired sheet separation is consequently not completed.

### SUMMARY

Embodiments of the present invention provide a method for separating plastically deformable plate-like workpieces of a workpiece stack. The workpieces are arranged adjacent to one another and are aligned with workpiece main planes parallel to one another. The method includes separating two adjacent workpieces from one another by generating a separating gap between the adjacent workpieces at a workpiece edge. The generating the separating gap includes acting upon at least one workpiece of the two adjacent workpieces by a force at an end side of the workpiece edge of the at least one workpiece parallel to a respective workpiece main plane, thereby compressing the at least one workpiece with formation of an edge-side thickened portion that projects perpendicular to the respective workpiece main plane with respect to a remaining portion of the at least one workpiece. As the at least one workpiece is acted upon by the force, the at least one workpiece is at least inhibited against an evasive movement caused by the force.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a mechanical separating device of a first design for separating sheets of a sheet stack according to some embodiments;

FIG. 2 shows a mechanical separating device of a second design for separating sheets of a sheet stack according to some embodiments;

FIG. 3 shows a feeding device of a mechanical arrangement for separating sheet processing, with a mechanical separating device of a third design for separating sheets of a sheet stack according to some embodiments;

FIG. 4 shows a feeding device of a mechanical arrangement for separating sheet processing, with a mechanical separating device of a fourth design for separating sheets of a sheet stack according to some embodiments;

FIG. 5 shows a forming tool of the mechanical separating devices according to FIGS. 1 to 4, according to some embodiments; and

FIG. 6 shows depictions to illustrate the mode of operation of the mechanical separating devices according to FIGS. 1 to 4, according to some embodiments.

### DETAILED DESCRIPTION

A mechanical method, a mechanical separating device, a mechanical feeding device and a mechanical arrangement for workpiece processing, in the case of which a functionally reliable separation of plastically deformable plate-like workpieces of a workpiece stack, in particular of plastically deformable sheets of a sheet stack, is ensured, are provided by embodiments of the present invention.

According to embodiments of the invention, a functionally reliable separation of workpieces, adjacent to one another, of a workpiece stack is brought about in that at least one of the workpieces adjacent to one another is acted upon by force on an end side of the workpiece edge parallel to the workpiece main plane and as a result is compressed with the formation of an edge-side thickened portion which protrudes perpendicular to the workpiece main plane with respect to the rest of the workpiece. In the event of the action of force, the workpiece which is plastically deformed under the lateral action of force is at least inhibited, preferably blocked against an evasive movement performed as a result of the action of force.

In order to generate the edge-side thickened portion of the corresponding workpiece, the separating device according to embodiments of the invention as a separating device comprises a forming tool which itself has a forming unit and a forming unit drive. The forming unit of the forming tool can be delivered into an operationally ready position laterally next to the workpiece stack. The forming unit drive moves the forming unit delivered into the operationally ready position with compression of the workpiece edge and generating the edge-side thickened portion of the workpiece with an operational movement from the operationally ready position against an end side of the workpiece edge of the workpiece to be separated.

The edge-side thickened portion generated by means of the forming tool of the separating device according to embodiments of the invention can protrude on the workpiece deformed on the edge side on one side or both sides and consequently form a separating gap only to one or to both adjacent workpieces.

In any event, as a result of the plastic deformation of the workpiece edge, a durable separating gap is produced between the workpiece deformed at the edge side and at least one workpiece adjacent to the workpiece deformed on the edge side in the workpiece stack.

As a result of the durability of the separating gap, the workpiece separation can also be performed chronologically independently of a subsequent workpiece transfer, for example, to a processing station of a mechanical arrangement for workpiece processing. A workpiece stack with one or more workpieces which are deformed at the edge and as a result prepared for removal from the workpiece stack can thus be stockpiled, for example, in a workpiece store.

The method according to embodiments of the invention and the separating device according to embodiments of the invention are suitable in particular also for separating stacked, non-magnetizable workpieces, for example, non-magnetizable sheets made of stainless steel or aluminum which cannot be separated from one another using magnetic repulsion forces as a result of the lack of magnetizability.

The method according to embodiments of the invention and the separating device according to embodiments of the invention are also advantageous as a result of their sheet thickness-independent mode of operation.

The durable deformation of the workpiece edge is in any event not damaging for the result of a manufacturing process which follows on from the workpiece separation when the workpiece edge remains as a remainder of the workpiece at the end of the manufacturing process. This is the case, for example, in the case of separating workpiece processing, in the case of which a scrap skeleton is produced as the waste product on which the thickened edge portion is located during workpiece separation.

The feeding device provided with the separating device according to embodiments of the invention is used to transfer workpieces taken up individually from a workpiece stack to a functional unit of a mechanical arrangement for workpiece processing. For example, a workpiece store or a processing device of the mechanical arrangement is possible as the functional unit.

Particular embodiments of the method and the devices according to the independent patent claims arise from the dependent patent claims 2 to 5, 7 to 13 and 15.

A functionally reliable generation of the edge-side thickened portion on the workpiece under the action of force is in particular ensured if the end side of the workpiece edge is acted upon by force impulsively (patent claim 2).

In a preferred configuration of the separating device according to embodiments of the invention, for this purpose, the forming unit drive of the forming tool has a drive means and a switchable drive lock. The forming unit delivered into the operationally ready position is initially pretensioned by means of the drive means for movement in the direction of the operating movement in the case of a drive lock switched into a locked state. By switching the drive lock from the locked state into a released state, the forming unit is released to perform the operating movement (patent claim 7). For example, a pretensionable spring which, as a result of its pretensioning after the release of the drive lock at the forming unit, provides the required force to generate the edge-side thickened portion of the workpiece acted upon is possible as a drive means of the forming unit drive.

In the interests of effective plastic deformation of the workpiece edge acted upon by the forming unit, the forming unit can, in a further development of the invention, taper in the direction of its operational movement generated by the forming unit drive, for example, in a wedge-shaped manner (patent claim 8). The forming unit is preferably formed to be flat on the workpiece side. In particular, a workpiece-side end face of the forming unit with a rectangular contour is conceivable according to embodiments of the invention.

A workpiece, which is arranged at the top in a workpiece stack of workpieces arranged on top of one another in the direction of gravity, exclusively as a result of its weight and the resulting friction on a workpiece lying thereunder, can be inhibited or blocked against an evasive movement under the effect of the action of force on the end side of the workpiece edge.

Once there is also the possibility according to embodiments of the invention to act on workpieces for workpiece separation which are arranged inside a vertical workpiece stack, it is provided in a preferred configuration of the method according to embodiments of the invention that the workpiece acted upon by force parallel to the workpiece main plane is at least inhibited, preferably blocked, against an evasive movement performed under the effect of the action of force in that the workpiece is, in the event of a loading acting in the direction of gravity, acted upon by force by at least one further workpiece, arranged above the workpiece, of the workpiece stack parallel to the workpiece main plane (patent claim 3). Additionally or alternatively, a mechanical stop for the workpiece can be provided on the end side of the workpiece remote from the action of force.

As a result of a corresponding dimensioning of the forming unit perpendicular to the workpiece main plane, it is possible in the case of a further design of the separating device according to embodiments of the invention to simultaneously generate an edge-side thickened portion required for workpiece separation with a single operating movement of the forming unit at several workpieces adjacent to one another in the workpiece stack (patent claims 4, 9).

In order to generate the operational movement of the forming unit of the forming tool, a forming unit drive formed as a linear drive is preferred according to embodiments of the invention, by means of which the forming unit delivered into the operationally ready position can be moved with a linear operational movement against the end side of the workpiece edge of the corresponding workpiece (patent claim 10).

In particular, an eccentric drive, a slider crank drive or a piston-cylinder drive is considered according to embodiments of the invention as a drive design.

In a further preferred configuration of the separating device according to embodiments of the invention, the delivery movement, with which the forming unit of the forming tool is arranged laterally next to the workpiece stack in the operationally ready position, is also generated mechanically (patent claim 11).

In one further development of the invention, the delivery device provided for this purpose is provided with a, preferably mechanical, guide device (patent claim 12).

Alternatively, a manual positioning of the forming unit or of the forming tool is conceivable.

In one preferred configuration of the feeding device according to embodiments of the invention, the forming tool of the separating device is provided on the supporting structure of the handling device of the feeding device. As a result of this, the forming unit of the forming tool of the mechanical separating device can be delivered into the operationally ready position by means of the handling device (patent claim 15).

In order to support workpiece separation, in the case of a further design of the separating device according to embodiments of the invention, in addition to the forming tool, an additional dividing device can be provided by means of which the separating gap generated by the plastic deformation of the workpiece edge can be expanded (patent claim 13). According to embodiments of the invention, for example, a blowing nozzle is provided as the additional dividing device, which blowing nozzle, after the forming of the workpiece edge of the workpiece(s) to be separated, is arranged laterally next to the workpiece stack. Compressed air is discharged by means of the blowing nozzle into the separating gap(s) formed as a result of the edge-side thickened portion, which compressed air brings about a substantial separation of the workpieces which are adjacent to one another. The additional dividing device can also be attached to the supporting structure of the handling device in the case of the feeding device according to embodiments of the invention.

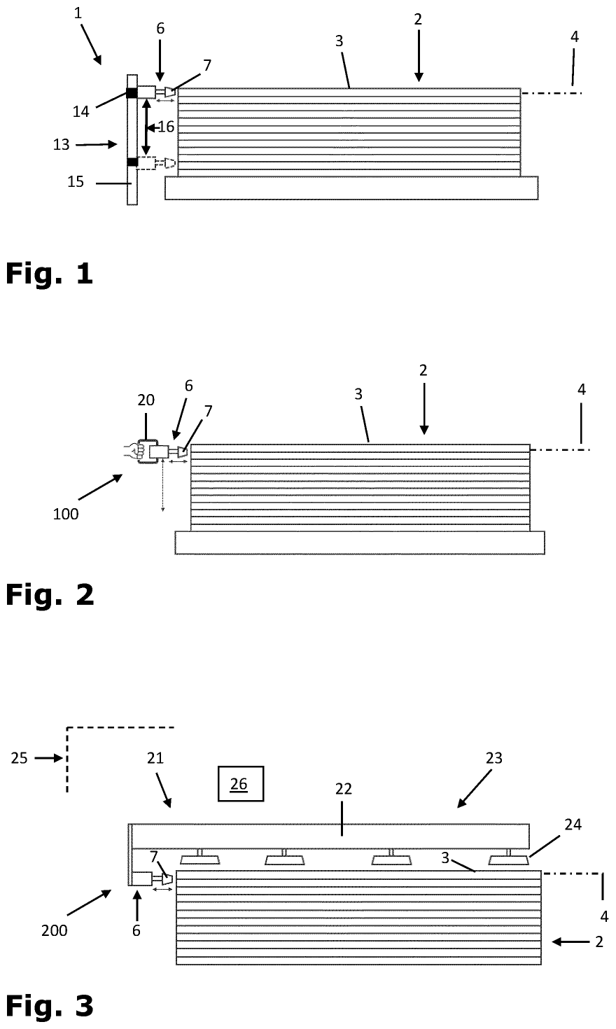

According to FIG. 1, a mechanical separating device 1 is arranged next to a sheet stack 2 provided as a workpiece stack of workpieces arranged on top of one another in the direction of gravity in the form of plastically deformable sheets 3. The sheets 3 are aligned parallel to one another with a workpiece or sheet main plane 4 indicated by a dot-dash line. The sheet material involves construction steel in the represented exemplary case.

The separating device 1 serves to separate the sheets 3 of the sheet stack 2. For this purpose, the separating device 1 comprises a dividing device in the form of a forming tool 6.

The forming tool 6 is represented in detail in FIG. 5.

According to FIG. 5, the forming tool 6 has a wedge-shaped forming unit 7 as well as a forming unit drive 9 arranged inside a drive housing 8.

In the represented exemplary case, the forming unit drive 9 is formed as a linear drive, in detail as a piston-cylinder drive. A piston rod 10 of the forming unit drive 9 is provided at the end with the forming unit 7 and at the opposite end covered in FIG. 5 by the drive housing 8 with a drive piston. The drive piston is guided movably on the inner wall of the cylindrical drive housing 8 in a retracting direction 11 and in a direction 12 of an operational movement of the forming unit 7.

Further components of the forming unit drive 9 which are also accommodated in the drive housing 8 are an electromagnet and a spring arranged on the side of the drive piston facing away from the forming unit 7.

In FIG. 5, the drive piston is held by the activated electromagnet in a rear end position located in the retracting direction 11. In the rear end position, the spring arranged on the side of the drive piston facing away from the forming unit 7 is compressed. The piston of the forming unit drive 9 and with it the forming unit 7 for movement in the direction 12 of the operational movement of the forming unit 7 are pretensioned by the compressed spring. The electromagnet of the forming unit drive 9 consequently forms a drive lock which, in the case of the functional state of the forming tool 6 according to FIG. 5, is switched into a locked state.

The forming tool 6 is also in this functional state in FIG. 1.

In FIG. 1, the forming tool 6 is delivered in the vertical direction into a tool position in which the forming unit 7 of the forming tool 6 is in an operationally ready position with respect to the sheet 3 lying at the top in the sheet stack 2. The forming tool 6 was moved into this position by means of a mechanical delivery device 13 of the separating device 1.

The delivery device 13 comprises a motor-operated delivery drive 14 of conventional design, by means of which the forming tool 6 can be positioned along a guide rail 15 which runs in the vertical direction and serves as a guide device. In an operationally ready position with respect to a sheet 3 close to the base in the sheet stack 2, the forming tool 6 is shown by a dashed line in FIG. 1. The vertical delivery direction of the forming tool 6 is illustrated by a double arrow 16 in FIG. 1.

In order to separate the sheet 3 arranged at the top in the sheet stack 2, starting from the conditions according to FIG. 1, the power is firstly cut off from the electromagnet of the forming unit drive 9 and as a result of this the drive lock, which was active until this point, of the forming unit drive 9 is transferred into a released state. As a result of this, the forming unit 7 is driven by the relaxing spring of the forming unit drive 9 impulsively in the direction 12 of the operational movement.

The mode of operation of the forming tool 6 is illustrated in FIG. 6 for a tool design, the forming unit 7 of which has on the sheet side a forming unit height, as a result of which the forming unit 7 extends perpendicular to the sheet main plane 4 over several sheets 3 which are adjacent to one another in the sheet stack 2.

As a result of its construction height, the forming unit 7 from FIG. 6 simultaneously meets the end side of a workpiece or sheet edge 17 on several sheets 3 which lie on top of one another in the sheet stack 2 during its operational movement in the direction 12. As a result of the plastic deformability of the sheets 3 and as a result of the circumstance that the forming unit 7 has a greater hardness than the sheets 3, the sheets 3 are compressed by the forming unit 7 with the formation of edge-side thickened portions 18. As a result of their weight, the sheets 3 acted upon by the forming unit 7 are blocked against lateral slipping under the action of the forming unit 7.

The edge-side thickened portions 18 generated by means of the forming unit 7 project perpendicular to the plate main plane 4 with respect to the respective rest of the sheet 3, on both upper sheets 3 in FIG. 6 with a protrusion on both sides. As a result of this, the edge-side thickened portions 18 on the sheets 3 bring about the formation of separating gaps 19 between sheets 3 which are adjacent to one another. In FIG. 1, a separating gap is generated in a corresponding manner between the sheet 3 lying at the top in the sheet stack 2 and the sheet 3 lying directly below it.

According to FIG. 6, the forming unit 7 has a triangular contour in a plane parallel to the sheet main plane 4. As a result of this, a linear contact arises at the end of the operational movement of the forming unit 7 between the forming unit 7 and the sheets 3 acted upon by the forming unit 7. Instead of the triangular contour, a trapezoidal contour of the forming unit 7 also indicated, for example, by a dashed line in FIG. 6 in the place parallel to the sheet main plane 4 would be conceivable. In the case of a trapezoidal contour, the forming unit meets the end side of the sheet edges 17 with a rectangular surface.

In both cases, the forming unit 7 tapers in the direction 12 of its operational movement.

The forming tool 6 of a mechanical separating device 100 represented in FIG. 2 is, in contrast to the forming tool 6 of the separating device 1 according to FIG. 1, delivered manually into a tool position, in which the forming unit 7 occupies the operationally ready position. Instead of the mechanical delivery device 13 according to FIG. 1, the forming tool 6 of the separating device 100 has a handle 20 by means of which the forming tool 6 can be positioned by an operator in the desired manner with respect to the sheets 3 to be separated of the sheet stack 2.

A mechanical separating device 200 shown in FIG. 3 is integrated into a mechanical feeding device 21. For this purpose, the forming tool 6 of the separating device 200 is fitted on a supporting structure formed as a suction frame 22 of a handling device 23. The suction frame 22 is additionally provided with sheet retaining devices in the form of retaining suckers 24 of conventional design.

The feeding device 21 is part of a mechanical arrangement 25 for sheet processing and serves in this case to load a sheet processing machine 26 provided as a functional unit of the mechanical arrangement 25. In order to load the sheet processing machine 26 with the sheet 3 lying at the top in the sheet stack 2, the forming tool 6 of the separating device 200 is delivered by means of the handling device 23 used as a mechanical delivery device with respect to the sheet 3 to be separated into a tool position, in which the forming unit 7 of the forming tool 6 is located with respect to the corresponding sheet 3 in the operationally ready position.

After separating the sheet 3 lying at the top in the sheet stack 2, the suction frame 22 of the handling device 23 is lowered with the retaining suckers 24 to the upper side of the separated sheet 3. A vacuum is subsequently applied to the retaining suckers 24 in a familiar manner and the sheet 3 fixed on the handling device 23 as a result can be transported by a corresponding movement of the handling device 23 to the sheet processing machine 26.

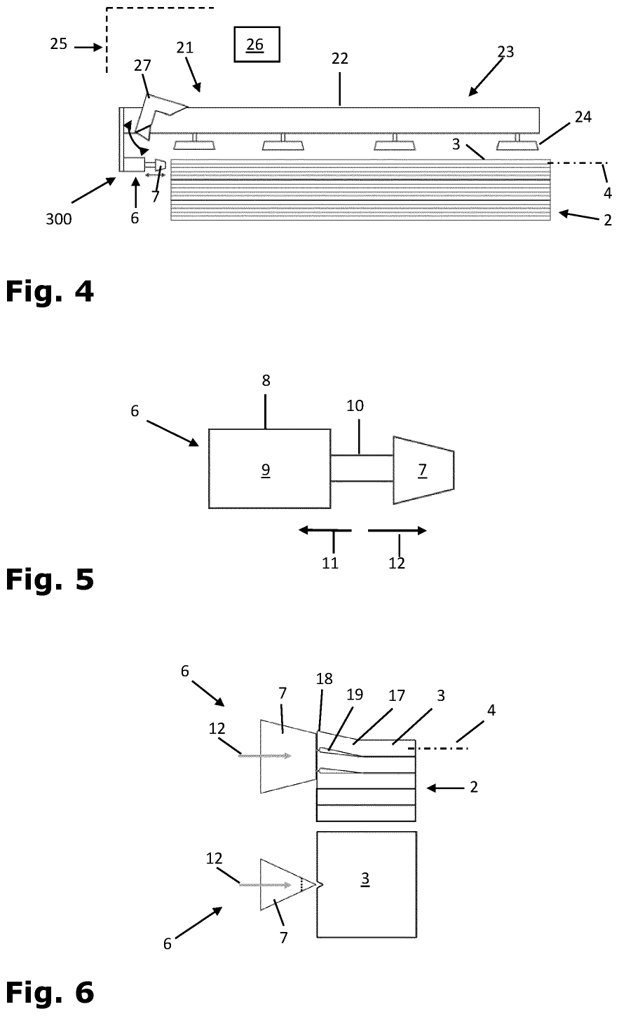

A mechanical separating device 300 shown in FIG. 4 differs from the separating device 200 according to FIG. 3 only in that, in addition to the forming tool 6, an additional dividing device in the form of a blowing nozzle 27 is provided. The blowing nozzle 27 is mounted in a pivotably movable manner on the suction frame 22 of the handling device 23. After generating a separating gap by means of the forming tool 6, the blowing nozzle 27 is pivoted laterally next to the sheet stack 2 into a position in which the blowing nozzle 27 can blow compressed air into the existing separating gap and as a result can expand the existing separating gap. The take-up of compressed air by means of the blowing nozzle 27 is performed at the same time as the start of the joint movement of the suction frame 22 and the sheet 3 held by means of the retaining suckers 24 on the suction frame 22.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for separating plastically deformable plate-like workpieces of a workpiece stack, wherein the workpieces are arranged adjacent to one another and are aligned with workpiece main planes parallel to one another, the method comprising:
separating two adjacent workpieces from one another by generating a separating gap between the adjacent workpieces at a workpiece edge,
wherein the generating the separating gap comprises:
acting upon at least one workpiece of the two adjacent workpieces by a force at an end side of the workpiece edge of the at least one workpiece parallel to a respective workpiece main plane, thereby compressing the at least one workpiece with formation of an edge-side thickened portion that projects perpendicular to the respective workpiece main plane with respect to a remaining portion of the at least one workpiece, wherein, as the at least one workpiece is acted upon by the force, the at least one workpiece is at least inhibited against an evasive movement caused by the force.

2. The method as claimed in claim 1, wherein the workpiece is acted upon by the force impulsively at the end side of the workpiece edge parallel to the workpiece main plane.

3. The method as claimed in claim 1, wherein the workpieces are arranged on top of each other in a direction of gravity in the workpiece stack, wherein the at least one workpiece which is acted upon by the force parallel to the workpiece main plane is at least inhibited against the evasive movement by a weight of at least one further workpiece arranged above the at least one workpiece.

4. The method as claimed in claim 1, wherein the acting upon the at least one workpiece by the force on the end side of the workpiece edge parallel to the workpiece main plane comprises:
delivering a forming unit of a forming tool laterally next to the workpiece stack into an operationally ready position, and
moving the forming unit from the operationally ready position with an operating movement against the end side of the workpiece edge, wherein as a result of the operating movement, the edge-side thickened portion on the at least one workpiece is generated.

5. The method as claimed in claim 1, wherein the acting upon at least one workpiece comprises simultaneously acting upon a plurality of workpieces which are adjacent to one another in the workpiece stack, thereby each workpiece of the plurality of workpieces is compressed with the formation of a respective edge-side thickened portion.

6. A separating device for separating plastically deformable plate-like workpieces of a workpiece stack, wherein the workpieces are arranged adjacent to one another and are aligned with workpiece main planes parallel to one another, the separating device comprising a dividing device configured to separate two workpieces adjacent to one another in the workpiece stack at a workpiece edge by generating a separating gap formed between the two workpieces,
wherein the dividing device comprises: a forming tool comprising a forming unit and a forming unit drive,
wherein the forming unit of the forming tool is capable of being delivered into an operationally ready position laterally next to the workpiece stack, and
wherein the forming unit delivered into the operationally ready position is capable of being moved by the forming unit drive from the operationally ready position with an operational movement parallel to the workpiece main plane against an end side of the workpiece edge of at least one workpiece of the workpieces adjacent to one another in the workpiece stack, thereby compressing the at least one workpiece at the workpiece edge and generating an edge-side thickened portion of the workpiece edge which protrudes perpendicular to the workpiece main plane with respect to a remaining portion of the at least one workpiece, wherein the at least one workpiece is at least inhibited against an evasive movement caused by the operational movement of the forming unit.

7. The separating device as claimed in claim 6, wherein
the forming unit drive comprises a drive and a switchable drive lock,
the forming unit is pretensioned in the operationally ready position as the drive lock is switched into a locked state by the drive for movement in a direction of the operational movement, and
the forming unit pretensioned in the operationally ready position for movement in the direction of the operational movement is capable of being released by switching the drive lock from the locked state into a released state in order to perform the operational movement.

8. The separating device as claimed in claim 6, wherein the forming unit tapers in a direction of the operational movement.

9. The separating device as claimed in claim 6, wherein the forming unit has, on a workpiece side, a forming unit height, so that the forming unit extends perpendicular to the workpiece main plane over a plurality of workpieces that are adjacent to one another in the workpiece stack.

10. The separating device as claimed in claim 6, wherein the forming unit drive comprises a linear drive, wherein the forming unit delivered into the operationally ready position is capable of being moved by the linear drive with a linear operational movement against the end side of the workpiece edge of the at least one workpiece.

11. The separating device as claimed in claim 6, further comprising a delivery device configured to deliver the forming unit of the forming tool into the operationally ready position.

12. The separating device as claimed in claim 11, wherein the delivery device comprises a guide device, wherein the forming tool is capable of being delivered in a guided manner through the guide device into a tool position which is assigned to the operationally ready position of the forming unit.

13. The separating device as claimed in claim 6, further comprising an additional dividing device, wherein the separating gap generated by the forming tool is capable of being increased in size by the additional dividing device.

14. A feeding device for feeding a functional unit of a mechanical arrangement for processing plastically deformable plate-like workpieces, the feeding device comprising:
a separating device as claimed in claim 11 for separating the plastically deformable plate-like workpieces of a workpiece stack, and
a handling device, wherein a workpiece separated by the separating device is capable of being moved to the functional unit of the mechanical arrangement,
wherein the handling device of the feeding device is provided as the delivery device of the separating device.

15. The feeding device as claimed in claim 14, wherein
the handling device has a supporting structure with holding devices for fixing a workpiece to be moved to the functional unit of the mechanical arrangement,
the forming tool of the separating device is provided on the supporting structure of the handling device, and
the forming unit of the forming tool of the separating device is capable of being delivered by a delivery movement of the supporting structure of the handling device into the operationally ready position.

16. An arrangement for processing plastically deformable plate-like workpieces, the arrangement comprising:
a functional unit, and
a feeding device as claimed in claim 14 for feeding the functional unit with a plastically deformable plate-like workpiece.
